(19) United States
(12) Patent Application Publication
(10) Pub. No.: US 2010/0036695 A1
(43) Pub. Date: Feb. 11, 2010

(54) Supply chain verification system

(76) Inventor: Sandra L. Kepler, Fairfield, IA (US)

Correspondence Address: Sandra L. Kepler, P.O. Box 647, Fairfield, IA, 52556, US

(21) Appl. No.: 12/218,257

(22) Filed: Jul. 14, 2008

(51) Int. Cl. G06Q 50/00; G06Q 90/00; G06Q 10/00

(52) U.S. Cl. 705/7; 705/500; 705/28

(57) ABSTRACT

Supply chain verification system with a multi brand level of information, a brand level of information, a product manufacturer level of information, a component level of information and a prime ingredient level of information. Each level of information remaining available to its own level or lower levels than its own, but not to higher levels than its own except for a central independent organization that has access to all the levels of the information for the purpose of evaluating and assuring a pre-set level of product quality. A preferred embodiment includes the information levels pertains to food quality and origination. A preferred embodiment includes the food quality is related to whether the food can be certified organic or not.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of computer based inventory monitoring systems and more specifically to a supply chain verification system. It is common practice in industry and agriculture to keep track of the origin and quality of components that go into the making of a product, whether it be a mass produced item made of plastic, metal and electronic components, or a food item that is comprised of multiple ingredients coming from a variety of sources. For example, Pape et al in his U.S. Pat. No. 6,664,897 discloses a system for livestock management where data is collected tracking data gathered from multiple RFID reader locations forming a web based quality assurance program for the beef industry. Menninger et al U.S. Pat. No. 6,954,736 discloses an order confirmation system in a supply chain management framework. The network uses electronic order forms from approved distributors to assure quality. U.S. Pat. No. 6,995,675 by Curkendall et al describes a system for data collection to provide quality assurance source verification and performance tracking for agricultural items.

However, none of the above mentioned patents provide a web based system that allows a central independent oversight agency to monitor all ingredients and components within a given product to assure that all the ingredients and components meet pre-set quality standards set by the independent agency. Furthermore, none of the above patents provides a system where users can view information relating to their own level, or levels below their own level, but not information that pertains to higher levels than their own. Additionally, none of the above patents provide a web based system that allows all the users in the line of product production to answer pre-programmed questionnaires or to upload already existing data spreadsheets to answer pre-programmed questions regarding quality and origination of product components. Finally, none of the prior patents discloses the addition of independent evaluators from a central oversight agency to verify the information filled in by the users through the process of independent on sight inspection.

### BRIEF SUMMARY OF THE INVENTION

The primary object of the invention is to provide a supply chain verification system that can track the origin and quality of components and component processing facilities to insure a pre-determined quality level for a given product.

Another object of the invention is to provide a supply chain verification system that allows each supplier of a component to register their information and supply it to a central evaluation center in a format that can be incorporated into a larger framework that creates a complete quality profile of a given product.

Another object of the invention is to provide a supply chain verification system that minimizes the effort needed by a manufacturer to insure product quality.

A further object of the invention is to provide a supply chain verification system that reduces unnecessary duplication of product quality information.

Yet another object of the invention is to provide a supply chain verification system that allows easy web based navigation making it easy for users to contribute information.

Still yet another object of the invention is to provide a supply chain verification system that includes security measures that prevent users from seeing data outside their own organization while allowing them to contribute supply chain information that leads to a certified high quality product.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed web based a supply chain verification system comprising: a multi brand level of information, a brand level of information, a product manufacturer level of information, a component level of information, a prime ingredient level of information, and each said level of information remaining available to its own level or lower levels than its own, but not to higher levels except for a central independent organization that has access to all said levels of said information for the purpose of evaluating and assuring a pre-set level of product quality.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram of the supply chain verification system of the present invention.

FIG. 2 is a sample of the welcome page sent to a brand manager

FIG. 3 is a sample of a multi brand input page.

FIG. 4 is a sample of a current brands page

FIG. 5 is a sample of a log in page.

FIG. 6 is a sample of a my supply chain page.

FIG. 7 is a sample of a current products page.

FIG. 8 is a sample of a product page that allows supplier comments.

FIG. 9 is a sample of a product page that allows evaluator comments.

FIG. 10 is a sample page that lists manufacturing facilities.

FIG. 11 is a sample page that assigns products to processing facilities.

FIG. 12 is a sample welcome page for manufacturing facilities.

FIG. 13 is a sample page where the supplier fills out product ingredients.

FIG. 14 is a sample farm survey form.

FIG. 15 is a sample page that lets the supplier list specific ingredients.

FIG. 16 is a sample page that identifies suppliers of risk ingredients.

FIG. 17 is a sample page that lists basic food ingredients by name.

FIG. 18 is a facility survey form.

FIG. 19 is a continuing facility survey form.

FIG. 20 is an additional continuing survey form.

FIG. 21 is a check out form.

FIG. 22 is an appointment form for an on site evaluation.

FIG. 23 is an input survey form for suppliers that do not own facilities.

FIG. 24 is an Email invite to suppliers that do not own facilities.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

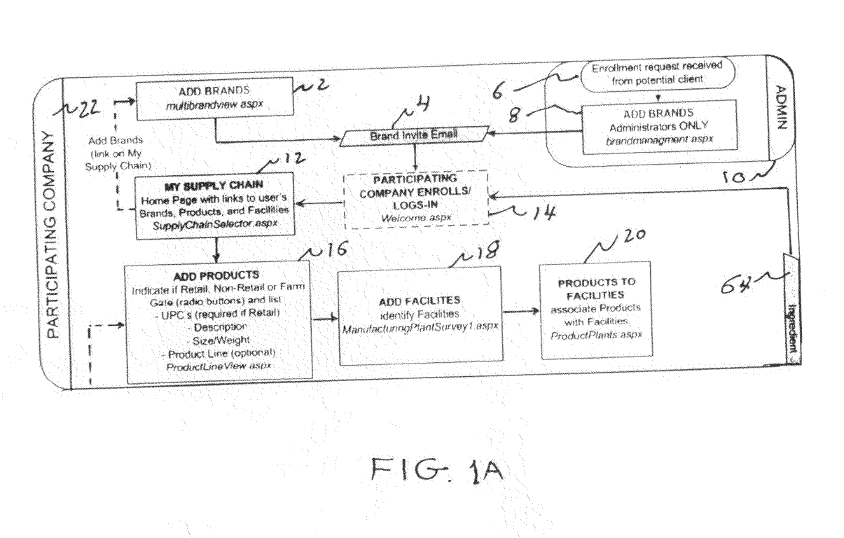

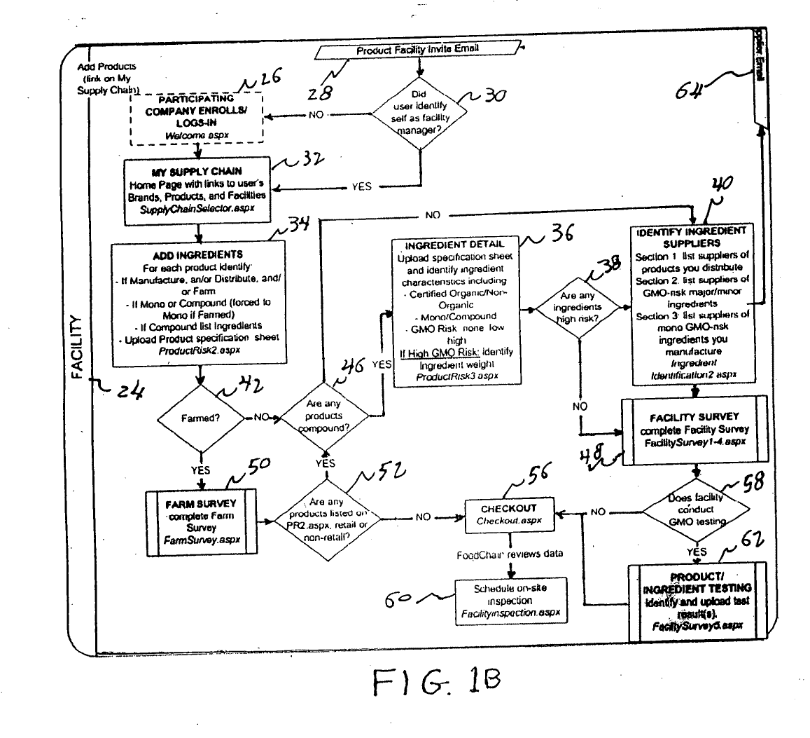

Referring now to FIG. 1 we see a block diagram of the supply chain verification system. The verification system is a supply chain compliance program that includes a software program for a computer based system that tracks the chain of events and the entities involved in those events, insuring that food ingredients and food producing facilities participating in the compliance program meet certain preset criteria set up by an independent oversight administrator organization. The food chain compliance system described in FIG. 1 is designed to insure that foods certified by the independent oversight administrator organization do not contain genetically modified organisms, otherwise known as GMO's. However, it should be understood that the basic model described in FIG. 1 can also be applied to other items that may require production oversight and certification, such as whether certain allergens are contained in a food product, or whether a food product is kosher. The model may also be applied to certify non-food items such as tracking and certifying that predetermined, environmentally friendly manufacturing techniques are adhered to in the entire chain of the production of a particular product.

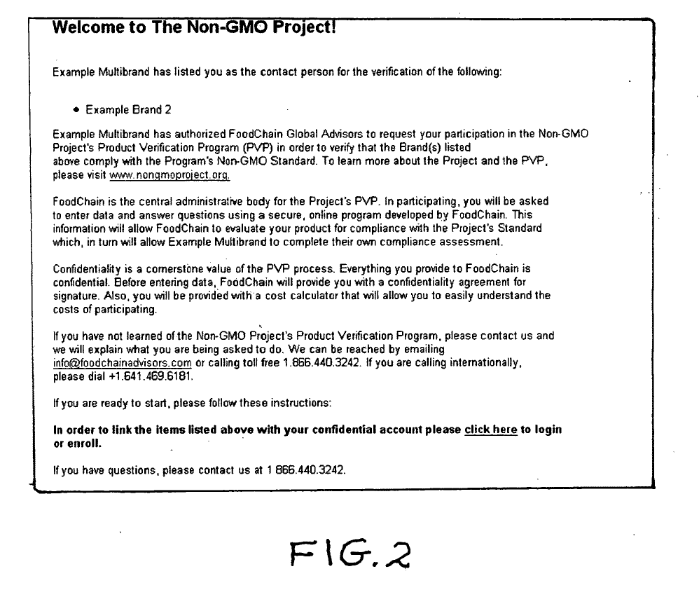

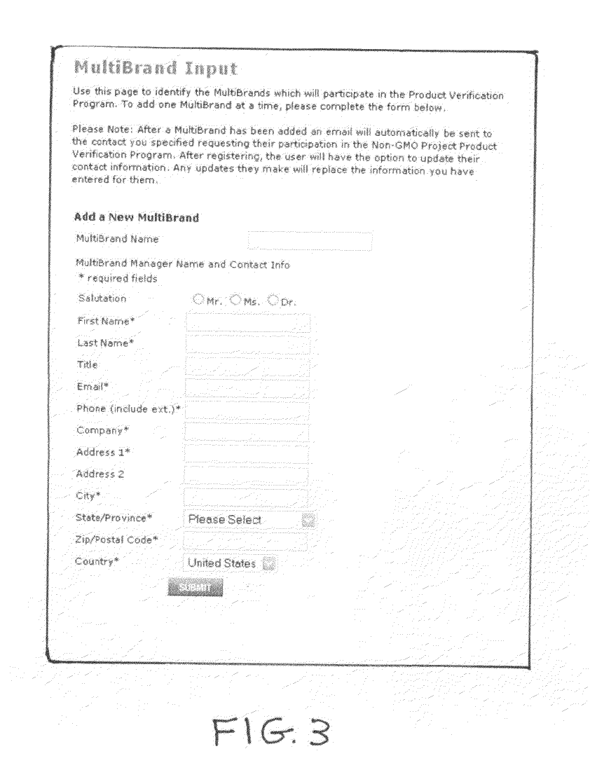

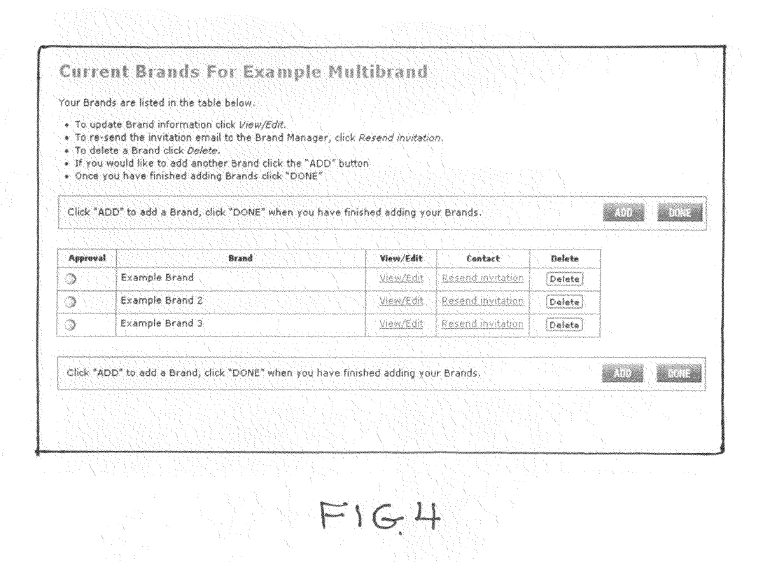

The diagram in FIG. 1 is broken up into two main sections. The first being inputting information about the participating company 22 and its brands 8, products 16 and facilities 18. The second being inputting information about activities that take place in a specific food processing facility 24 including the names of the participating companies 26, the ingredients used 34 all the way down to the most basic ingredients grown at the farm level 50. Participating companies are invited to join by receiving a brand invite Email 4 as shown in FIG. 2. Alternately, a company may approach the independent oversight organization and ask to join 6. The independent oversight organization will then input information about the potential new member 8 as shown in FIG. 3. If accepted, brands are officially added to the system by the oversight administrator 10. Once the new user is accepted, the owner of a particular food brand or brands will fill out information 2 about what brands the owner represents as shown in FIG. 4. After a company becomes an approved participant that is to be monitored and certified by the oversight organization, they can log into the site by entering their user name and password 14 as shown in FIG. 5.

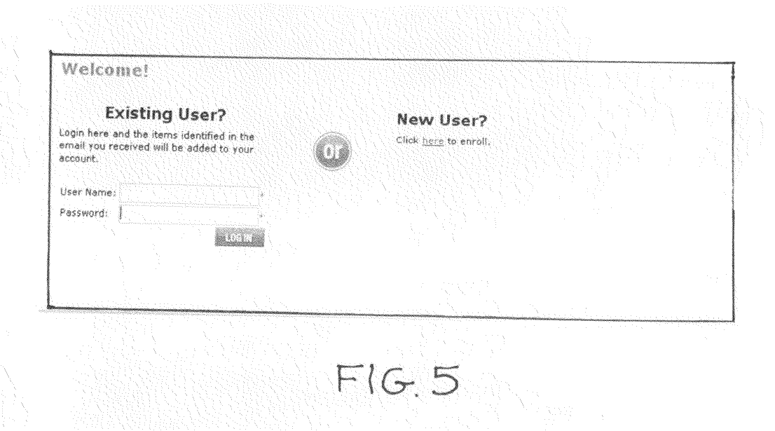

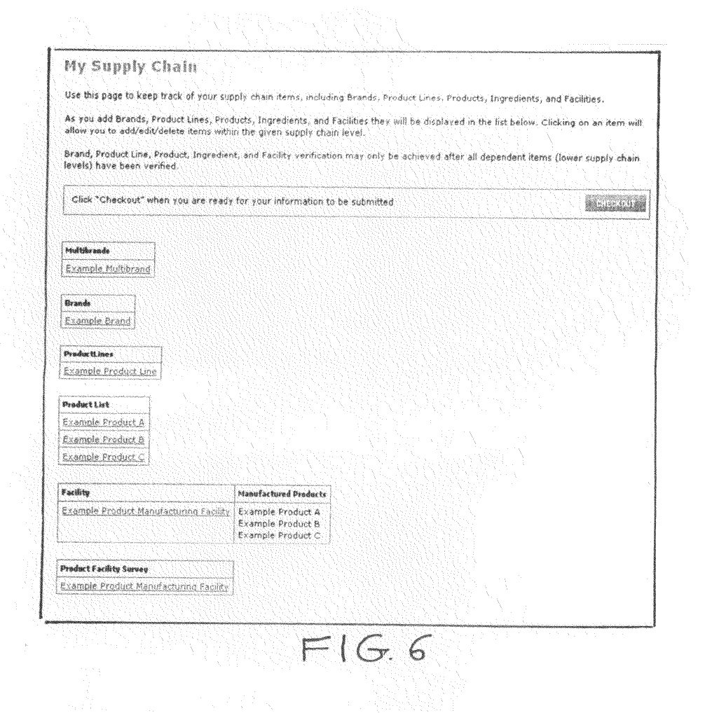

After the participants log on to the site, they can view their home page 12, as shown in FIG. 6, that shows the user's Brands, Product and facilities. An important aspect of the present novel supply chain software system is that a member, if given clearance by the suppliers below him, can look down the chain of suppliers to see that they are all in compliance with the preset regulations issued by the oversight administrator. If the brand owner has not been given permission to see the information supplied by the suppliers in his chain, than only the oversight administrator can see the complete picture of suppliers and their status as certified or not.

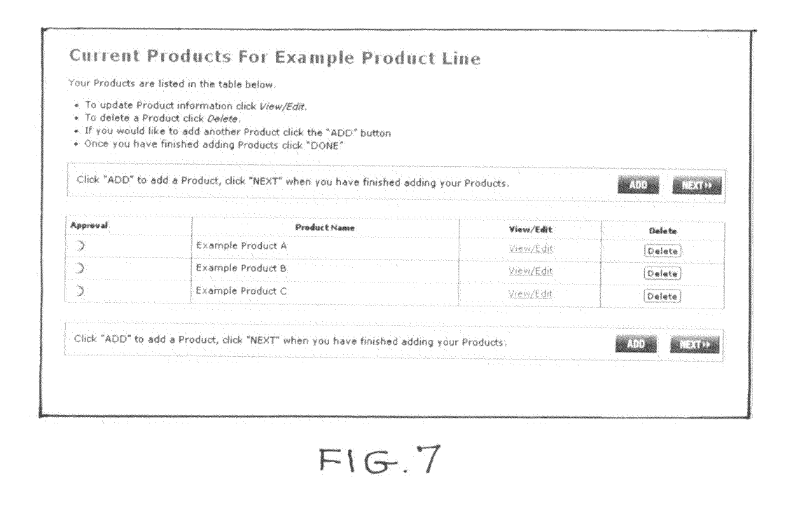

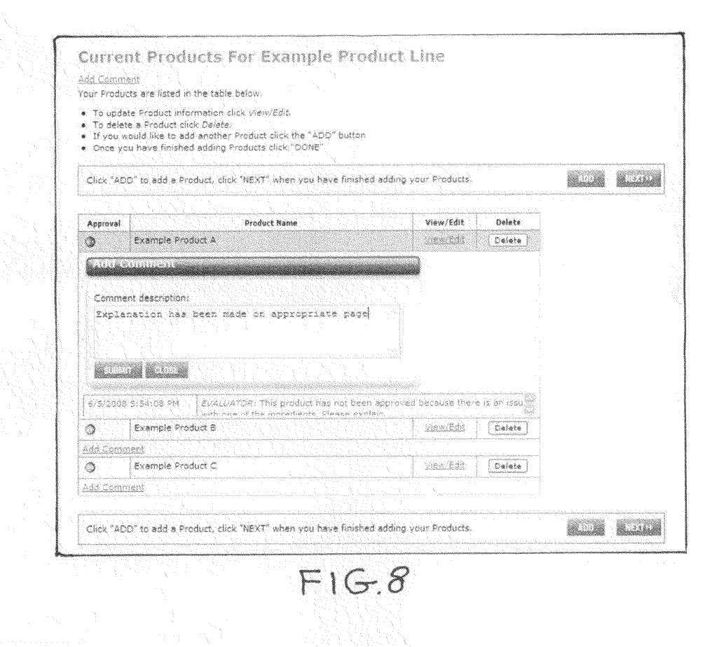

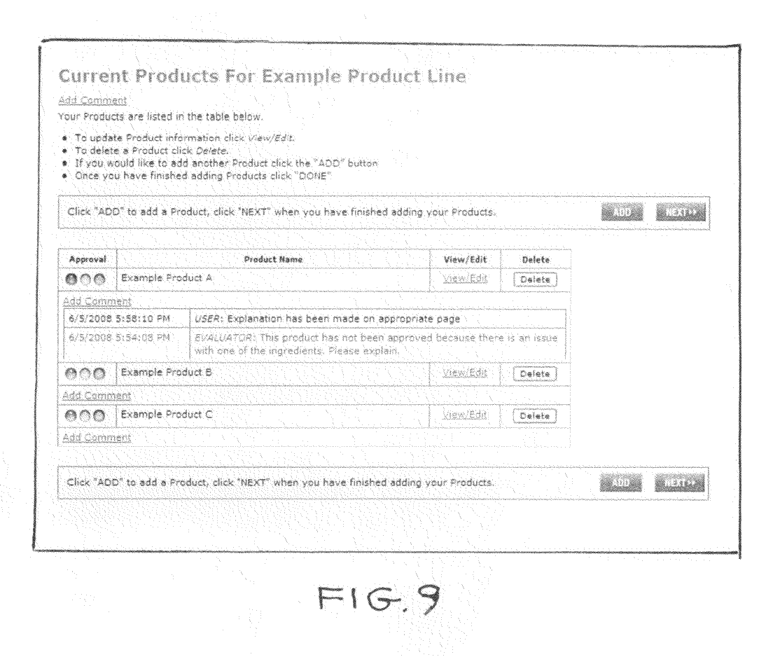

A member of a participating company can add information about products contained within a brand by filling out a questionnaire 16 as shown in FIG. 7. If a member wants to add specific comments about a specific product, he or she can do so by typing in the comment section as shown in FIG. 8. If an evaluator that is part of the oversight organization wants to add a comment regarding a particular product, he or she can do so by typing in the comment section as shown in FIG. 9.

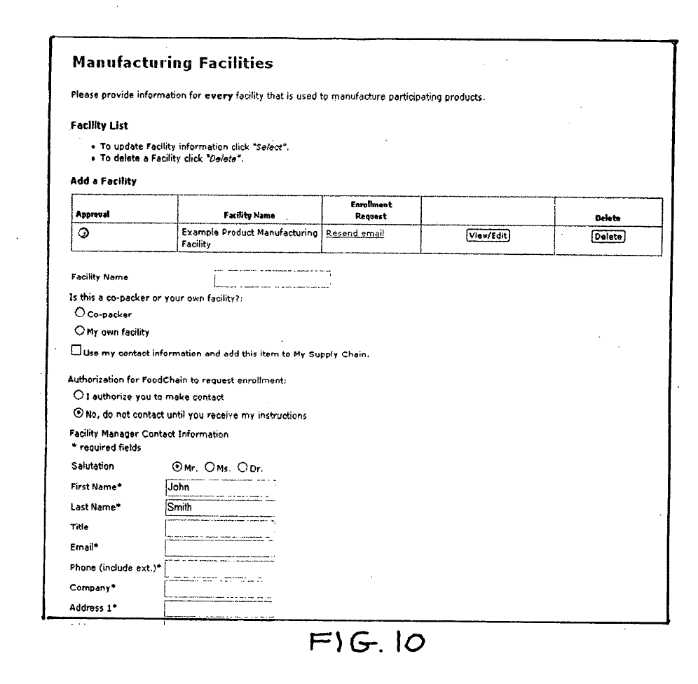

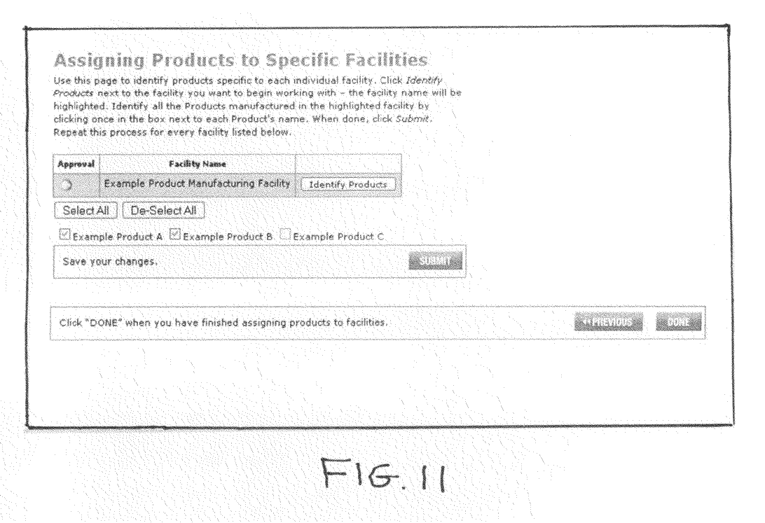

If the member owns a manufacturing facility that produces a food product, the member adds the facility 18 by filling out the form shown in FIG. 10. The products are linked to the facility that they are made in 20 by filling out the form shown in FIG. 11.

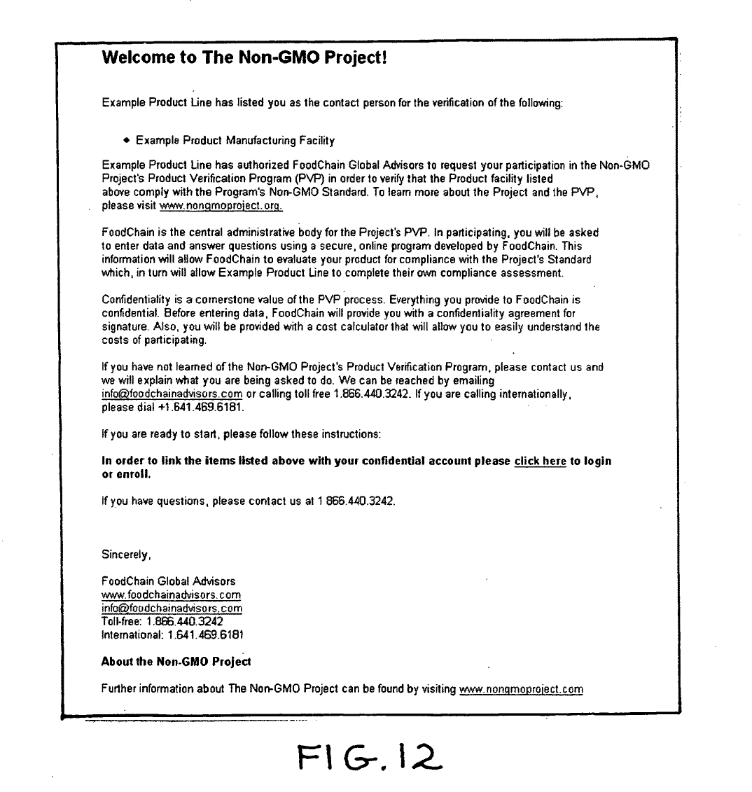

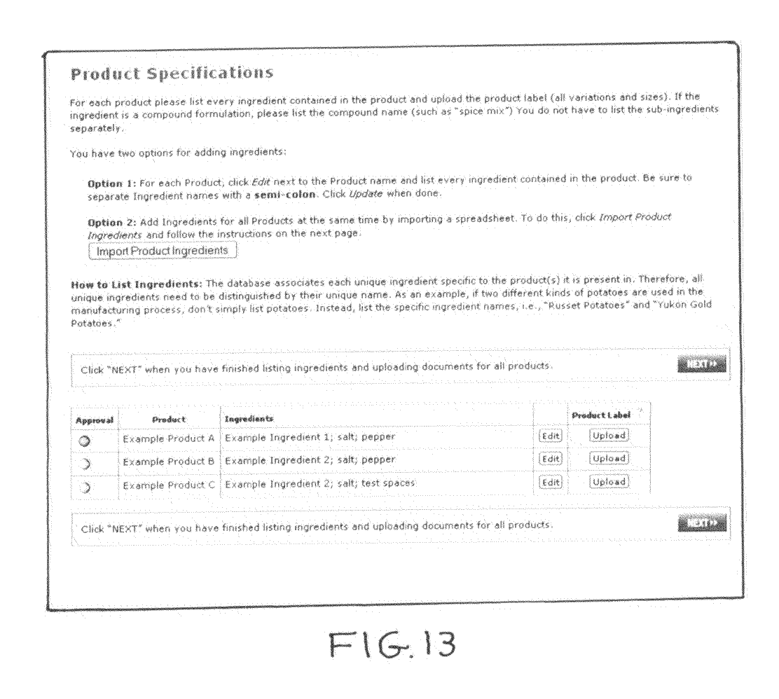

An ingredient suppler Email 64 can be sent by a brand participant to request that the supplier join the oversight organization thereby insuring that the ingredient supplier meets the organizations standards. Or the ingredient supplier can initiate this process on his own by requesting to participate in the certification program. Facilities that are involved with the manufacture of a specific product or products are sent an invite Email by the product or brand owner 28 as shown in FIG. 12. If the receiver of the invite Email identifies himself as a facility manager 30, then he is directed to the My Supply Chain home page 32 as shown in FIG. 6 and proceeds to fill out forms regarding the nature of the ingredients used 32 in each product as shown in FIG. 13. The receiver can either fill out each section of the questionnaire or he can import, or upload the information from his already existing information file. If the receiver of the invite Email is not a manager then he is directed to a log in site 26 that in turn directs the appropriate company official to the home page 32 as shown in FIG. 6.

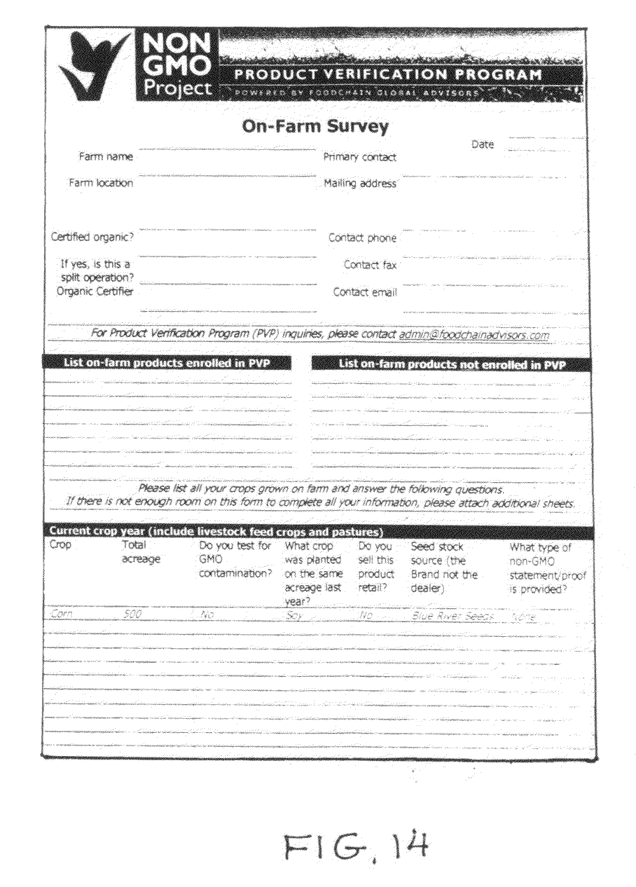

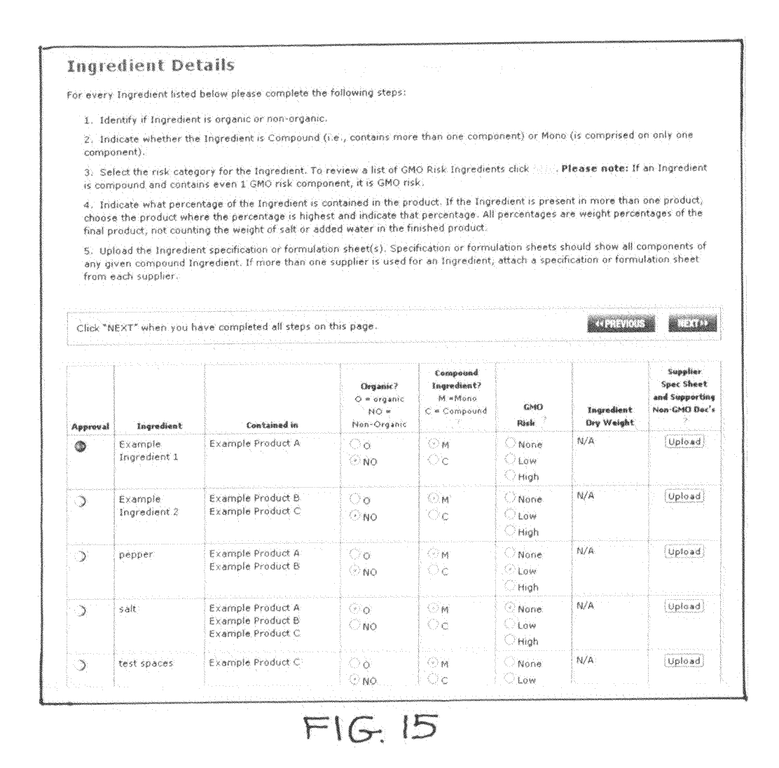

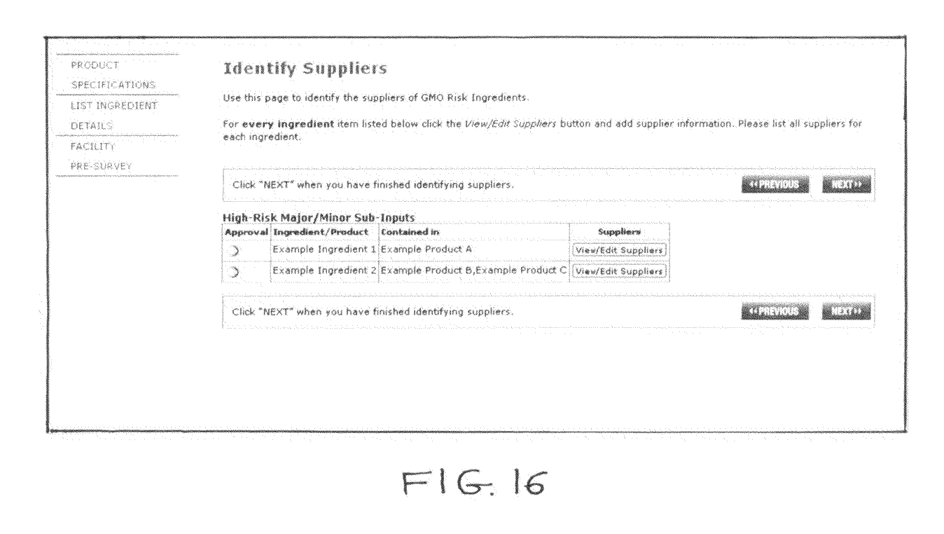

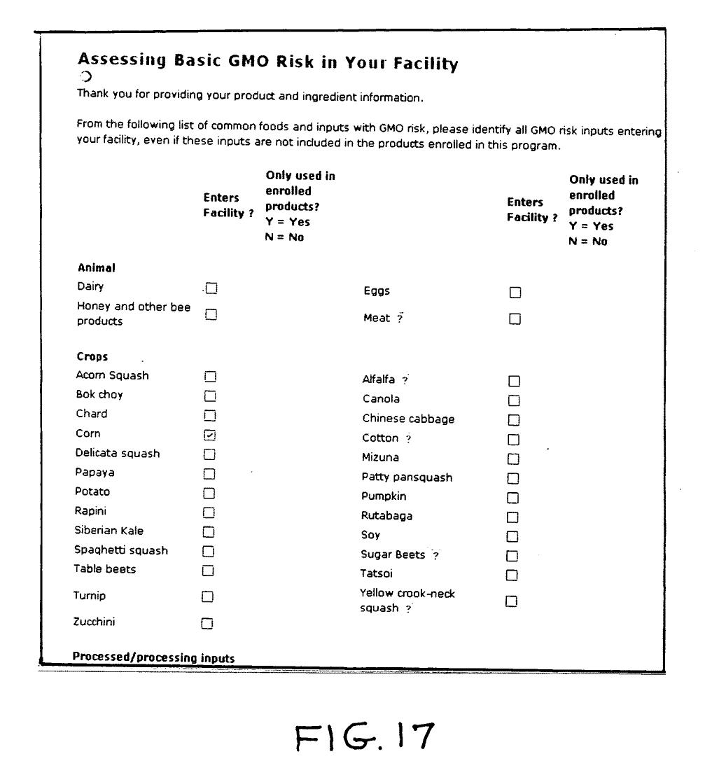

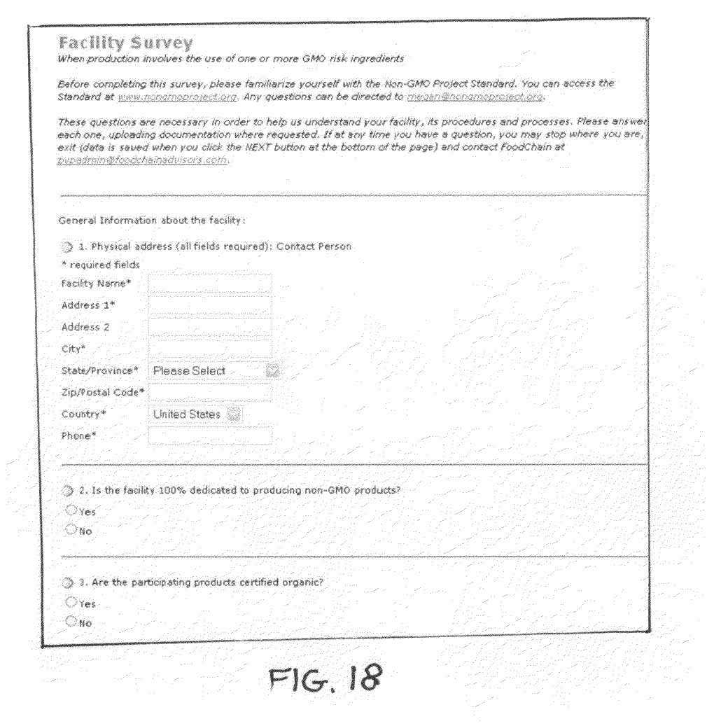

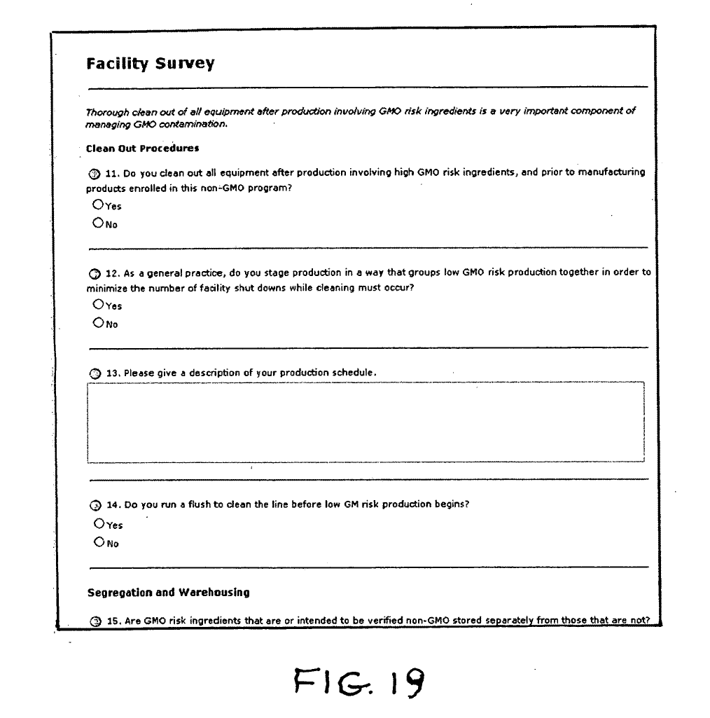

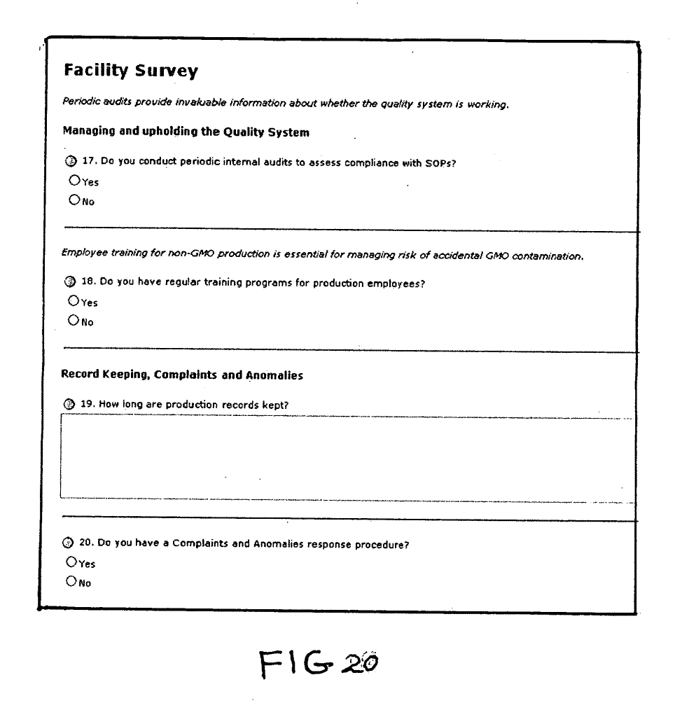

If the ingredient is a farmed ingredient 42, meaning that it is in its most basic form, the user is directed to a farm survey form 50 as shown in FIG. 14. If the ingredient is a compound 46 made up of sub ingredients, then the sub ingredients are listed in the detail ingredient form 36 as shown in FIG. 15. If an ingredient is a high GMO risk 38, the user fills out information regarding the identity of suppliers as shown in FIG. 16. If the ingredient is at low risk for GMO's, or the user is not sure, then the user is directed for fill out the GMO assessment form 48A as shown in FIG. 17 and then to fill out the facility survey form 48B, 48C, 48D as shown in FIGS. 18, FIG. 19 and FIG. 20.

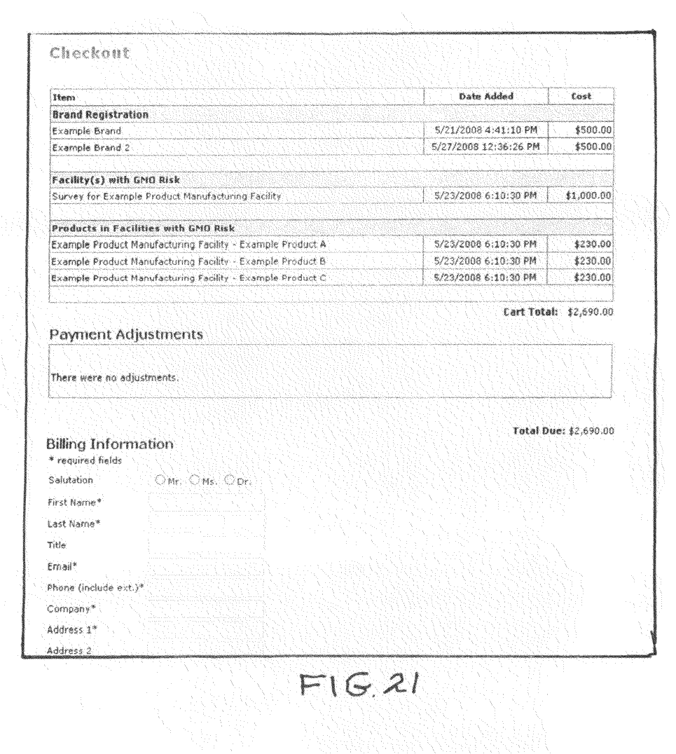

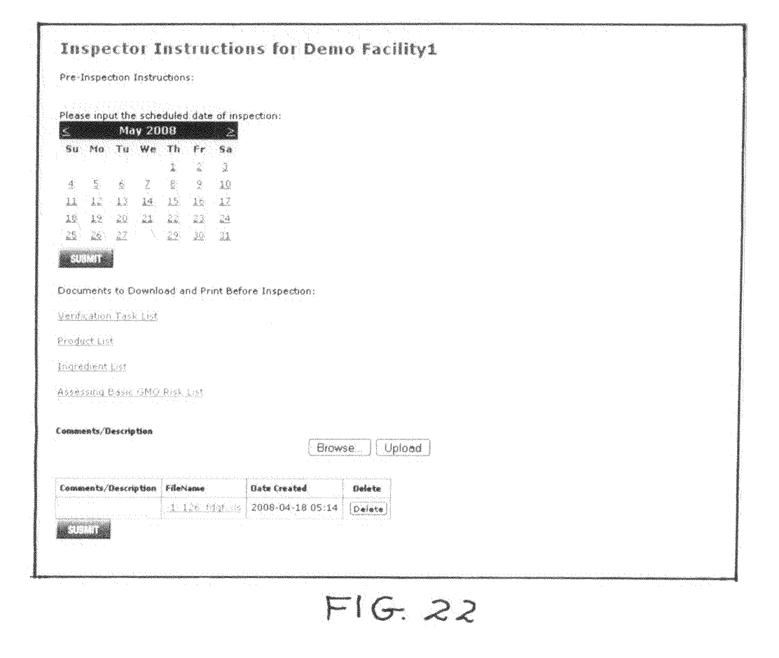

After the user has completed the Farm Survey 50, he is asked whether the products listed are meant for retail sales or non retail sales 52. If the product is not meant for retail sales then the user proceeds to the checkout portion 56 of the program where he is shown the cost for having the oversight organization evaluate the information supplied by the applicant and then pay the cost as shown in the sample check out page on FIG. 21. After payment is received an on sight inspection 60 is arranged as shown in FIG. 22.

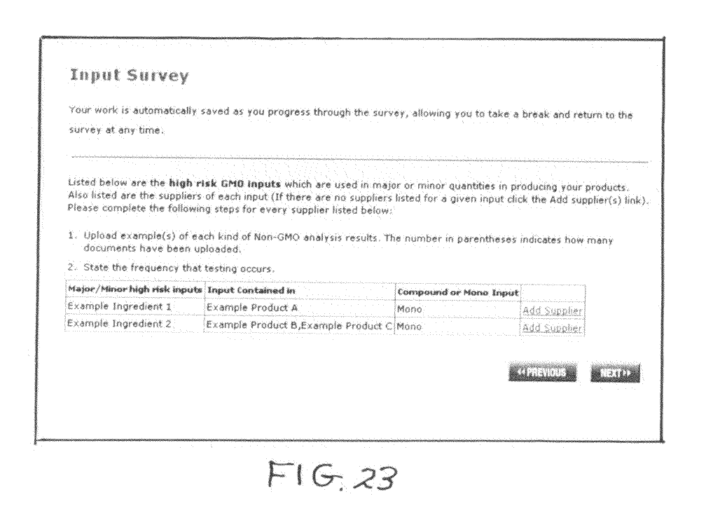

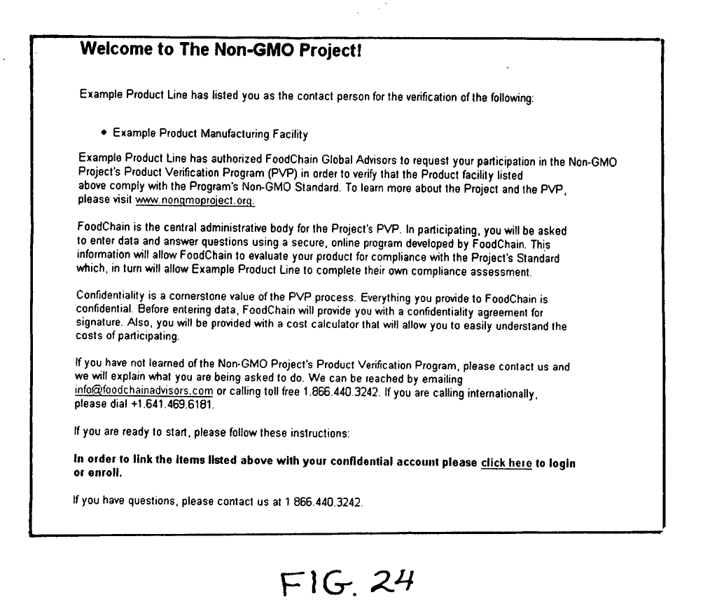

If the facility does not conduct its own GMO testing 48, the user is directed to the checkout portion of the program 56. If the facility does do its own testing the applicant is directed to upload the results of those tests 62 as shown by FIG. 23.

In some cases an ingredient supplier may not actually have a facility of its own. In that case an Email will be sent 64 to the supplier by a processing facility as shown in FIG. 64 and the information from the supplier will then be sent to the participating brand owner 14 so that it can be included in the supply chain 12.

The supply chain verification system described and illustrated above allows each supplier of a food ingredient component to register their information and supply it to a central evaluation center in a format that can be incorporated into a larger framework that creates a complete quality profile of a given food product. This minimizes the effort needed by a manufacturer to insure product quality. The system also reduces unnecessary duplication of product quality information. It also allows easy web based navigation making it easy for users to contribute information. The information is secured by the central compliance organization. The information can only be seen by other members of the compliance organization if specific permission has been given by other members associated with the manufacture of the food item involved.

The entire system allows the components of a particular food product to be independently analyzed down to the most basic farm grown ingredient so that the food product can be given an official certificate that the processed food has met the criteria of the independent oversight organization.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. supply chain verification system comprising:
a multi brand level of information;
a brand level of information;
a product manufacturer level of information;
a component level of information;
a prime ingredient level of information; and
each said level of information remaining available to its own level or lower levels than its own, but not to higher levels except for a central independent organization that has access to all said levels of said information for the purpose of evaluating and assuring a pre-set level of product quality.

2. supply chain verification system as claimed in claim 1 wherein each said levels of information can be added to easily by having suppliers record required information onto pre designed computer based questionnaires.

3. supply chain verification system as claimed in claim 1 wherein evaluators from said central independent organization review said supplier information and also evaluate said supplier's manufacturing facility to make sure it passes pre-determined criteria for earning said central organization's seal of approval.

4. supply chain verification system as claimed in claim 1 wherein said supplier can upload said suppliers spread sheets related to product quality and origination.

5. supply chain verification system as claimed in claim 1 wherein said information levels pertains to food quality and origination.

6. supply chain verification system as claimed in claim 5 wherein said food quality is related to whether said food can be certified organic or not.

7. supply chain verification system as claimed in claim 5 wherein said food quality is related to whether said food uses genetically modified ingredients or not.

8. supply chain verification system as claimed in claim 1 wherein said levels of information are collected and serve as the centralized store house for the said information and production techniques throughout the entire chain of said product manufacturing.
